(19) United States
(12) Patent Application Publication
(10) Pub. No.: US 2026/0320518 A1
(43) Pub. Date: Oct. 15, 2026

(54) METHODS AND SYSTEMS FOR AUTOMATIC CONSTRUCTION PROGRESS TRACKING

(71) Applicant: DroneDeploy, Inc., San Francisco, CA (US)

(72) Inventors: Philip LORENZO, Davis, CA (US); Nicholas PILKINGTON, Seattle, WA (US); Jonathan MILLIN, San Francisco, CA (US); Demet GENCER, Cedar Park, TX (US)

(21) Appl. No.: 19/179,502

(22) Filed: Apr. 15, 2025

(51) Int. Cl. G06Q 10/0631; G06Q 50/08; G06T 11/60; G06V 10/62; G06V 10/77; G06V 10/82; G06V 20/10

(52) U.S. Cl. CPC G06Q 10/063114; G06Q 50/08; G06T 11/60; G06V 10/62; G06V 10/7715; G06V 10/82; G06V 20/176; G06V 2201/10

(57) ABSTRACT

A computer-implemented method for automatically tracking construction progress includes receiving, at one or more processors communicatively coupled to one or more image sensors, processed imaging data including one or more images of a construction site. The images have been captured by image sensors equipped with an imaging system. The method further includes processing, using a vision large language model (LLM) executed by the processors, the images to identify a status at the site of (i) at least one physical structure or (ii) at least one site condition. Processing includes extracting features to generate structured data representations of the images, identifying an object within those representations indicative of a site status, classifying the object using a transformer-based neural network to determine a semantic category of the status, and generating a textual description that characterizes the status based on at least the semantic category of the status.

### TECHNICAL FIELD

The present disclosure relates to methods and systems for automatically processing, analyzing, and describing source files of imaging data for construction progress tracking applications. More specifically, the present disclosure relates to methods and systems for automatically generating descriptions of changes to a construction site based on temporally spaced imaging data.

### BACKGROUND

It is often necessary to track the progress of ongoing projects in the construction industry. Such tracking may be needed for schedule adherence, monitoring of labor and material usage, and compliance with various regulations. Conventional methods for progress tracking generally involve manual site observations and review of 2D or 3D drawings or models. These legacy approaches may be time-consuming, expensive, and prone to errors.

Current solutions to the aforementioned issues in the field may require extensive preparation of building information models, which may take on the order of weeks to months to properly configure with project data and various other construction documentation to begin reporting on progress. Even after such lengthy setup phases, such solutions often still involve labor-intensive manual review by numerous human experts who are tasked with comparing captured site imagery against the planned elements in a model. These existing processes demand a high level of technical expertise to correctly interpret construction plans and map them to project schedules, which may exacerbate financial and time-related costs.

Accordingly, there is a need for improved systems, devices, and methods for detecting, comparing, and reporting construction progress in a more efficient and expedited manner.

### SUMMARY

Each of the aspects disclosed herein may include one or more of the features described in connection with any of the other disclosed aspects. Aspects of the disclosure may relate to systems, devices, and methods for automatically generating descriptions of changes to a construction site based on temporally spaced imaging data.

For example, a computer-implemented method for automatically tracking construction progress may include receiving, at one or more processors communicatively coupled to one or more image sensors, a set of processed imaging data including one or more images of a construction site. The one or more images may have been captured by the one or more image sensors each equipped with an imaging system. The computer-implemented method may further include processing, using a vision large language model (LLM) executed by the one or more processors, the one or more images to identify a status at the construction site of (i) at least one physical structure or (ii) at least one site condition. The processing may include performing feature extraction to generate one or more structured data representations of the one or more images, identifying an object within the one or more structured data representations indicative of a status at the construction site, classifying the object using a transformer-based neural network to determine a semantic category of the status and generating a textual description that characterizes the identified status at the construction site based on at least the semantic category of the status.

Any of the systems, devices, and methods disclosed herein may include any of the following features. The one or more image sensors may include a first image sensor and a second image sensor, the first image sensor and the second image sensor being a same image sensor or different image sensors. The one or more images may include one or more first images that have been captured by the first image sensor at a first time and one or more second images that have been captured by the second image sensor at a second time. The identified object within the one or more structured data representations may be a modification between the one or more first images and the one or more second images, and the status at the construction site may be a change at the construction site indicated by the modification.

The one or more images each may include associated metadata, and the one or more structured data representations may be generated further based on the metadata associated with the one or more images.

The set of processed imaging data may be based on one or more source files that have had at least one of feature extraction, semantic segmentation, or edge detection applied by a preprocessing server.

The set of processed imaging data may include metadata including at least one of timestamp data, geolocation data, sensor data, lens data, photographic setting data, sensor calibration data, or sensor angle data, and the identifying of the status at the construction site may be further based on the metadata.

The textual description may include at least one standardized descriptive term.

The computer-implemented method may further include transmitting, by the one or more processors, a scheduling request to a scheduling server, receiving, by the one or more processors, a scheduling response including scheduling data from the scheduling server, and utilizing, by the one or more processors, the vision LLM to generate a progress report. The progress report may be based on at least one of the at least one description or the scheduling data.

The computer-implemented method may further include utilizing, by the one or more processors, the vision LLM to generate an analysis of the construction site. The analysis may be based on the progress report.

The computer-implemented method may further include receiving, by the one or more processors, a data inquiry from a user device. The data inquiry may include at least one reference to a portion of the construction site.

The computer-implemented method may further include utilizing, by the one or more processors, the vision LLM to generate a data response. The data response may be based on at least one of the progress report, the scheduling data, or the data inquiry.

The scheduling data may include at least one of an activity ID, an activity name, a start date, a finish date, a location ID, or a building level.

The progress report may be a first progress report. The first progress report may be further based on a second progress report generated by the vision LLM.

This disclosure may further include a system for automatically tracking construction progress, the system including one or more processors, and one or more non-transitory computer readable media storing instructions which, when executed by the one or more processors, cause the one or more processors to perform operations including receiving, a set of processed imaging data including one or more images of a construction site. The one or more images may have been captured by one or more image sensors each equipped with an imaging system, and processing, using a vision large language model (LLM), the one or more images to identify a status at the construction site of (i) at least one physical structure or (ii) at least one site condition. The processing may include performing feature extraction to generate one or more structured data representations of the one or more images, identifying an object within the one or more structured data representations indicative of a status at the construction site, classifying the object using a transformer-based neural network to determine a semantic category of the status, and generating a textual description that characterizes the identified status at the construction site based on at least the semantic category of the status.

Any of the systems, devices, and methods disclosed herein may include any of the following features. The one or more image sensors may include a first image sensor and a second image sensor, the first image sensor and the second image sensor may be a same image sensor or different image sensors. The one or more images may include one or more first images that have been captured by the first image sensor at a first time and one or more second images that have been captured by the second image sensor at a second time, and the identified object within the one or more structured data representations may be a modification between the one or more first images and the one or more second images, and the status at the construction site may be a change at the construction site indicated by the modification.

The one or more images each may include associated metadata, and the one or more structured data representations may be generated further based on the metadata associated with the one or more images.

The set of processed imaging data may be based on one or more source files that may have had at least one of feature extraction, semantic segmentation, or edge detection applied by a preprocessing server.

The set of processed imaging data may include metadata including at least one of timestamp data, geolocation data, sensor data, lens data, photographic setting data, sensor calibration data, or sensor angle data. The identifying of the status at the construction site may be further based on the metadata.

The textual description may include at least one standardized descriptive term.

This disclosure further may further include one or more non-transitory computer readable media for automatically tracking construction progress, the one or more non-transitory computer readable media storing instructions which, when executed by one or more processors, cause the one or more processors to perform operations including receiving a set of processed imaging data including one or more images of a construction site. The one or more images may have been captured by one or more image sensors each equipped with an imaging system, and processing, using a vision large language model (LLM), the one or more images to identify a status at the construction site of (i) at least one physical structure or (ii) at least one site condition. The processing may include performing feature extraction to generate one or more structured data representations of the one or more images, identifying an object within the one or more structured data representations indicative of a status at the construction site, classifying the object using a transformer-based neural network to determine a semantic category of the status, and generating a textual description that characterizes the identified status at the construction site based on at least the semantic category of the status.

Any of the systems, devices, and methods disclosed herein may include any of the following features. The one or more image sensors may include a first image sensor and a second image sensor, the first image sensor and the second image sensor may be a same image sensor or different image sensors. The one or more images may include one or more first images that have been captured by the first image sensor at a first time and one or more second images that have been captured by the second image sensor at a second time. The identified object within the one or more structured data representations may be a modification between the one or more first images and the one or more second images, and the status at the construction site may be a change at the construction site indicated by the modification.

It may be understood that both the foregoing general description and the following detailed description may be exemplary and explanatory only and may be not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 depicts a diagram of an example system 100 for automatically analyzing and describing a set of source files of imaging data of a project site, according to aspects of this disclosure.

FIG. 2 depicts a diagram of example components of a device 200 that may execute the techniques described in the present disclosure.

FIG. 3A depicts an illustrated “before” image of a project site captured by an unmanned aerial vehicle for use by the system 100, according to aspects of this disclosure.

FIG. 3B depicts an illustrated “after” image of a project site captured by an unmanned aerial vehicle for use by the system 100, according to aspects of this disclosure.

FIG. 4 depicts a first call flow between the various elements of system 100, according to aspects of this disclosure.

FIG. 5 depicts a first example method performed by progress server 130 for tracking project progress, according to aspects of this disclosure.

FIG. 6 depicts a second call flow between the various elements of system 100, according to aspects of this disclosure.

FIG. 7 depicts a second example method performed by progress server 130 for tracking project progress, according to aspects of this disclosure.

### DETAILED DESCRIPTION

As discussed in the background section, existing solutions for project progress tracking may be expensive, time-consuming, or error prone. Such inefficiencies drive cost and delay throughout a project.

To address the foregoing, the present disclosure provides methods and systems for automatically generating descriptions of changes to a project site over time based on temporally spaced imaging data (e.g., unmanned aerial vehicle images and/ or ground-based images) to detect and describe project progress with minimal dependence on preconfigured building information models. In this manner, the present disclosure may provide a technical improvement in the field by enabling faster, more accurate, and more scalable detection of new work (e.g., progress) on a project site, thereby reducing both manual labor and data overhead typically needed for progress tracking.

Moreover, the systems, devices, and methods of the disclosure may apply vision-based and multimodal large language models to imaging data to interpret “before and after” imagery to systematically and automatically generate standardized progress descriptions (e.g., progress reports), which may be further augmented by integration with project scheduling databases and analytic platforms. The approaches described herein may provide near-real-time project insights, accelerate overall feedback loops for project stakeholders, and enhance the scalability of automated site monitoring.

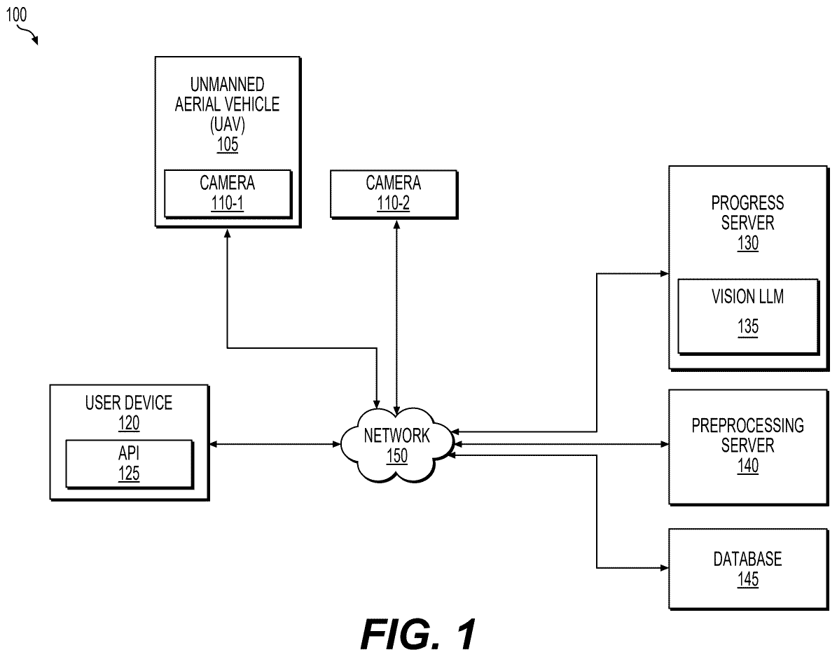

FIG. 1 is a diagram of an example system 100 for automatically analyzing and describing a set of source files of imaging data of a project site. As used herein, the term “project site” is broadly defined to include any physical location, area, or environment in which activities, processes, or operations related to a specific project, plan, or activity are performed, planned, monitored, or assessed. A project site may include, without limitation, construction sites, renovation or remodeling sites, infrastructure or development sites or zones, maintenance or repair sites, manufacturing or industrial sites, storage sites, staging sites, inspection sites, disaster recovery or remediation sites, environmental sites, and any other locations associated with project-related activities. Additionally, a project site may include both indoor and outdoor settings, permanent or temporary workspaces, mobile or fixed environments, as well as remote, distributed, or otherwise geographically dispersed locations.

As shown in FIG. 1, the system 100 may include an unmanned aerial vehicle (UAV) 105, a camera 110-1, a camera 110-2, a user device 120, an application programming interface (API) 125, a progress server 130, a vision LLM 135, a preprocessing server 140, a database 145, and a network 150.

The UAV 105 (e.g., a drone or any vehicle or machine that can be controlled remotely) may include a device configured to fly above, around, within, etc., a region of interest. For example, the UAV 105 may be a multi-rotor drone, a fixed-wing drone, a single-rotor drone, a vertical take-off and landing (VTOL) drone, a satellite, or the like. Alternatively or additionally, a ground-based device equipped with a camera may be used. For example, a vehicle or a robot with an integrated camera may be utilized either alongside or as an alternative to a UAV.

The camera 110-1 and/or the camera 110-2 may be a device configured to capture imaging data of a region of interest. For example, the camera 110-1 and/or the camera 110-2 may be a digital camera, a thermal camera, a hyperspectral camera, or the like. One of ordinary skill in the art will appreciate that various camera formats may also be used without departing from the scope of the disclosure. For example, a camera (or a device including a camera) may be held by, attached to, or otherwise affixed to a project worker (e.g., a bodycam). In another example, a camera may be part of a virtual reality (VR), augmented reality (AR), or mixed reality (MR) headset.

The systems, devices, and methods of the disclosure may utilize cameras of various formats or types. For example, project progress reports may be based on imaging data contemporaneously generated by a camera implemented on a UAV (e.g., the UAV 105), a camera held by a person, a bodycam, a vehicle or robot-mounted camera, and/or a fixed CCTV camera.

In some aspects of the disclosure, the user device 120 may be a device configured to receive a set of source files of imaging data corresponding to a region of interest captured by the camera 110-1, and/or the camera 110-2. In some aspects of the disclosure, the user device 120 may act as a relay between one or more camera devices and one or more servers. For example, the UAV 105 (e.g., camera 110-1) may transmit imaging data and/or metadata to the user device 120. Such a relay implementation may be desirable in certain remote operating environments. In other aspects of the disclosure, the devices corresponding to cameras 110-1 and/or 110-2 may directly transmit payloads to the safety server 130 in a substantially similar manner as described with respect to the user device 120.

The user device 120 may be a smartphone, a laptop computer, a desktop computer, a server, or the like. In other aspects of the disclosure, the devices corresponding to cameras 110-1 and/or 110-2 may directly transmit payloads to progress server 130 in a substantially similar manner as described with respect to user device 120.

The API 125 may be an interface that permits the user device 120 and the progress server 130 to communicate. For example, the user device 120 (and/or UAV 105, camera 110-1, etc.) may provide a set of payloads to the progress server 130 via the API 125. User device 120 may receive progress report information, analytics, and/or chat responses from progress server 130.

The progress server 130 may include a device configured to execute a vision large language model (LLM) to detect differences in temporally spaced preprocessed imaging data and describe said differences in the imaging data, or additionally or alternatively, to detect and describe what is found in the imaging data without comparing temporally spaced preprocessed imaging data. This description can be either in a broadly applicable sense or by comparing against a predefined list of project trade terminologies. The progress server 130 may also receive scheduling data from a scheduling server, generate a progress report, analytics, and/or chat responses and transmit said progress reports, analytics, and/or chat responses to the user device 120. For example, the progress server 130 may be a server, a cloud server, a virtual machine, or the like.

The vision LLM 135 may include a model configured to receive a set of preprocessed imaging payloads as an input from a preprocessing server 140, to detect differences in temporally spaced imaging data, describe said differences in the imaging data, receive scheduling data from a scheduling server, generate a progress report, analytics, and/or chat responses and transmit said progress reports, analytics, and/or chat responses to the user device 120 as one or more outputs. For example, the vision LLM 135 may be a neural network. The vision LLM 135 may apply heuristics to consider the logical progress of work on the project site. For example, the detection of installed drywall may imply that stud framing and insulation behind the drywall were already installed.

The preprocessing server 140 may be a device configured to receive imaging payloads from various input sources, including unmanned aerial vehicles (e.g., UAV 105), ground-based cameras (e.g., CCTV, bodycams), vehicle-mounted cameras, and other imaging devices. The preprocessing server 140 may organize, standardize, and process imaging payloads—including both image data and associated metadata—before transmitting the refined data to progress server 130. The preprocessing server 140 may be a server, a cloud server, a virtual machine, or the like.

The preprocessing server 140 may execute a series of data conditioning steps to optimize imaging payloads for efficient analysis by progress server 130. These one or more steps may include image format conversion, resolution normalization, geospatial alignment, noise reduction, and/or compression to ensure uniformity across various imaging devices. The preprocessing server may cluster imaging payloads based on various schema. A schema may define a particular set of metadata, a particular set of values of the metadata, a particular relationship between values of the metadata, particular thresholds, etc., that are used to cluster, classify, and/or validate the imaging payloads.

Preprocessing server 140 may extract, validate, and structure metadata such as timestamps, geolocation data, sensor data, lens data, photographic settings (including aperture, ISO, and/or shutter speed), sensor calibration data, and/or sensor angle (e.g., pitch, roll, and/or yaw). Preprocessing server 140 may apply one or more computer vision algorithms such as feature extraction, semantic segmentation, and/or edge detection to enhance image clarity and highlight key elements within a scene, such as structural components or material stockpiles. Preprocessing server may apply these techniques to various types of imaging, including traditional optical (e.g., RGB), thermal (e.g., infrared), near-infrared, Light Detection and Ranging, (LiDAR), and other known imaging techniques, alone or in combination.

The preprocessing server 140 may apply machine learning algorithms to perform automatic image quality control. For example, preprocessing server 140 may detect corrupted, blurry, or incomplete images that may otherwise compromise downstream analysis at progress server 130. Once fully processed, the standardized imaging payloads are transmitted by preprocessing server 140 to the vision LLM 135 of progress server 130.

The database 145 may include a device configured to store source files, payloads, digital imaging assets, scheduling information, and/or the like. For example, the database 145 may be a centralized database, a distributed database, a cloud database, a network database, a hierarchical database, or the like. Database 145 may be queried by progress server 130 for various scheduling data. Scheduling data may be analyzed by progress server 130 to generate more informative and relevant progress reports. Relevant scheduling data may include an activity ID, an activity name, a building name, a level, an interior/exterior indicator, a location ID, a location name, a start data, and/or a finish date. Scheduling data may be linked or otherwise have a relationship with other scheduling data. For example, a first activity (e.g., electrical installation) may always precede another activity (e.g., drywall installation). Such relationships may allow the progress server 130 to better estimate the impact of delays in its progress reports.

The network 150 may be a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a satellite network, an air-to-ground network, future contemplated networking standards such as 6G, and the like, and/or a combination of these or other types of networks.

The number and arrangement of the devices of the system 100 shown in FIG. 1 are provided as an example. In practice, the system 100 may include additional devices, fewer devices, different devices, or differently arranged devices than those shown in FIG. 1. Additionally, or alternatively, a set of devices (e.g., one or more devices) of the system 100 may perform one or more functions described as being performed by another set of devices of the system 100.

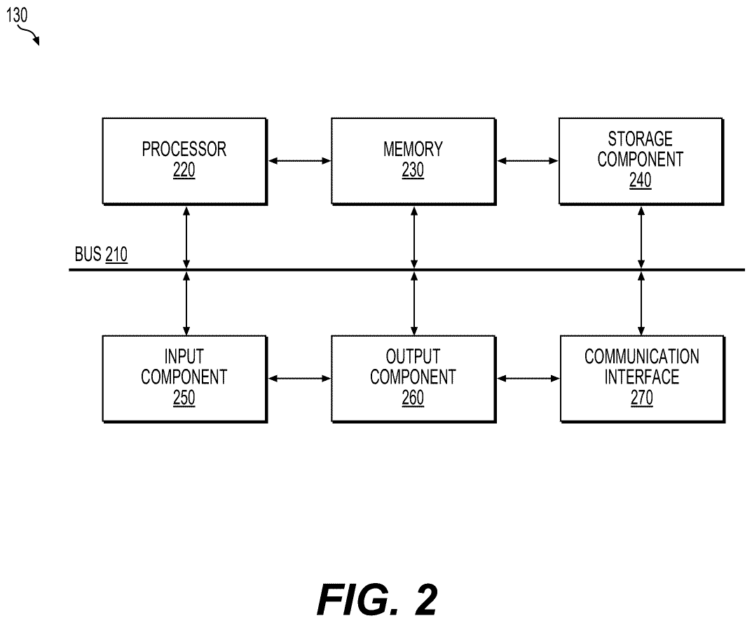

FIG. 2 is a diagram of example device that may execute the techniques described herein. The device 200 may correspond to the UAV 105, the camera 110-1, the camera 110-2, the user device 120, the progress server 130, the preprocessing server 140, and/or the database 145. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 may be implemented in hardware, firmware, or a combination of hardware and software. In some aspects, processor 220 may include specialized cores optimized for parallel processing or machine-learning tasks. The processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component.

The processor 220 may include one or more processors capable of being programmed to perform a function. The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g., a touch screen display, a keyboard, a keypad, a mouse, a button, a switch, and/or a microphone for receiving the reference sound input). Additionally, or alternatively, the input component 250 may include a sensor for sensing information (e.g., a global positioning system (GPS) component, an accelerometer, a gyroscope, and/or an actuator). The output component 260 may include a component that provides output information from the device 200 (e.g., a display, a speaker for outputting sound at the output sound level, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes based on the processor 220 executing software instructions stored by a non-transitory computer-readable medium, such as the memory 230 and/or the storage component 240. A computer-readable medium may be defined herein as a non-transitory memory device. A memory device may include memory space within a single physical storage device or memory space spread across multiple physical storage devices.

The software instructions may be read into the memory 230 and/or the storage component 240 from another computer-readable medium or from another device via the communication interface 270. When executed, the software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of the components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

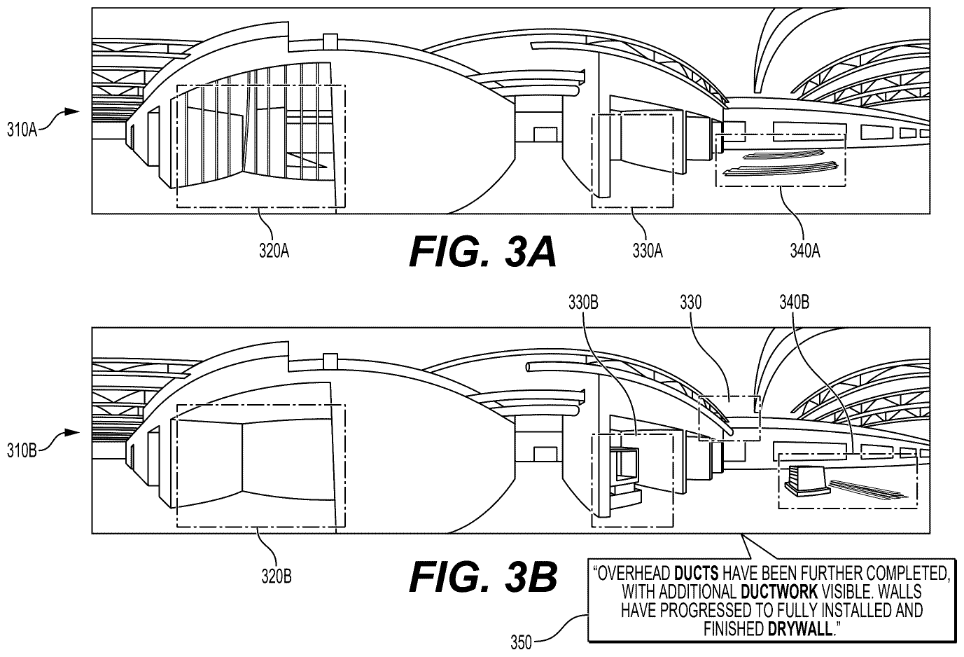

FIGS. 3A and 3B depict illustrated “before” and “after” images of a project site captured by an unmanned aerial vehicle (or any other device including a camera) for use by the system 100, according to aspects of this disclosure. In FIGS. 3A and 3B, reference numerals with ‘A’ correspond to “before” images an element and reference numerals with ‘B’ correspond to “after” images of an element.

The systems, devices, and methods of the present disclosure may systematically and automatically generate standardized progress descriptions (e.g., progress reports). In particular, the progress server 130 may leverage computer vision and natural language techniques (e.g., a vision LLM) to identify key elements of project progress (e.g., new framing, completed ductwork, installed fixtures) within sequences of images captured over time. The vision models may map these identified elements to project milestones by cross-referencing metadata (e.g., geolocation tags, timestamps) and project schedules (e.g., start dates, finish dates, predecessor tasks) stored in associated databases.

The temporal spacing between “before” and “after” images can vary based on operator preference and specific implementation. For example, changes may be tracked on the order of minutes, hours, days, weeks, months, or years. Such varying time scales may be used to generate progress reports of varying scope. In an example, an operator may require daily and weekly progress reports. In such an example, UAV 105 may be deployed manually or automatically at intervals corresponding to the desired reporting interval. For example, daily flights by UAV 105 may be used to generate daily reports (e.g., where the total elapsed time between “before” and “after” images is one day). In another example, long periods (e.g., years) between progress reports may be desirable for tracking decay or breakdown of structures, such as trusses on a bridge.

FIG. 3A depicts an illustrated “before” image of a project site captured for use by the system 100, according to aspects of this disclosure. An imaging scene 310A depicts a portion of a project site at a first time, T1. The imaging scene 310A includes several notable imaging landmarks. Landmark 320A shows that a portion of the wall does not include drywall (e.g., showing exposed beams).

Another landmark in imaging scene 310A is ductwork area 330A. Ductwork area 330A may be a portion of the project site intended to ultimately include ductwork. Ductwork area 330A shows the absence of ductwork at T1. Yet another landmark in imaging scene 310A is material staging area 340A. Material staging area 340A may include various project materials intended for use in other areas of the project site. For example, material staging area 340A depicts wooden beams for use in wall project elsewhere on the site. One of ordinary skill in the art will appreciate that various materials may be recognized in the imaging scene and that reference to a specific material staging area is for explanatory purposes.

FIG. 3B depicts an illustrated “after” image of the project site captured for use by the system 100, according to aspects of this disclosure. An imaging scene 310B depicts the same portion of a project site shown in FIG. 3B at a second time, T2, where T2 occurs after T1. As mentioned previously, the timescale between T1 and T2 may vary based on specific implementation.

The imaging scene 310B includes the same landmarks shown in FIG. 3A. Landmark 320B shows that the portion of the wall now does include drywall (e.g., no longer showing exposed beams). Another changed landmark in imaging scene 310B is ductwork area 330B. Ductwork area 330B now shows the presence of ductwork at T2. Yet another changed landmark in imaging scene 310B is material staging area 340B. Material staging area 340B now includes a material pallet, which was not present at T1 in FIG. 3A.

The aforementioned differences between imaging scenes may be detected and described by progress server 130, further description of which is provided below. While FIGS. 3A and 3B show changes to an indoor space, one of ordinary skill in the art will appreciate that the systems, devices, and methods described herein may be applicable to any part of a project site. For example, system 100 may track changes to a building exterior, earthwork, aesthetic changes, and the like.

It is to be understood that the “before and after” views shown in FIGS. 3A and 3B, along with the described exemplary changes to landmark locations (e.g., drywall installation, ductwork placement, and material stockpiling), are presented merely as illustrative examples of the types of site modifications that may be detected and described by the systems, devices, and methods of the disclosure. As such, the disclosed embodiments are not limited to any particular set of project tasks, materials, or site conditions, and may be adapted to any number of other industrial, commercial, or residential project processes.

Moreover, the time intervals and frequency of capture for the imaging data (e.g., images, videos, or other sensor readings) may be selected or modified to suit the specific demands of different projects. In some instances, a daily capture schedule may be beneficial for rapidly progressing tasks, while more extended intervals may suffice for slower-moving or less critical activities. In some aspects, different capture technology may be applied at different times of day. For example, UAV 105 may be deployed twice daily, in the morning (to capture RGB optical imaging) and in the evening (to capture infrared imaging). Both such captures may be compared against old imaging of the same type to generate a progress report. An example description of a detected change is provided with description 350, which as an example, generally states that ductwork and walls have progressed since T1.

While FIGS. 3A and 3B highlight indoor site progression, the disclosed systems, devices, and methods may similarly be applied to outdoor areas, infrastructure projects, renovation sites, excavation and earthworks, equipment staging, or any other environment where it is desirable to automatically monitor changes over time. Hence, the embodiments described herein are neither limited to new projects nor limited to any single project type.

Any references made to specific structures, materials, or components on a project site are provided solely for purposes of clarity and example. The systems, devices, and methods described in this disclosure may include additional or alternative structures and components.

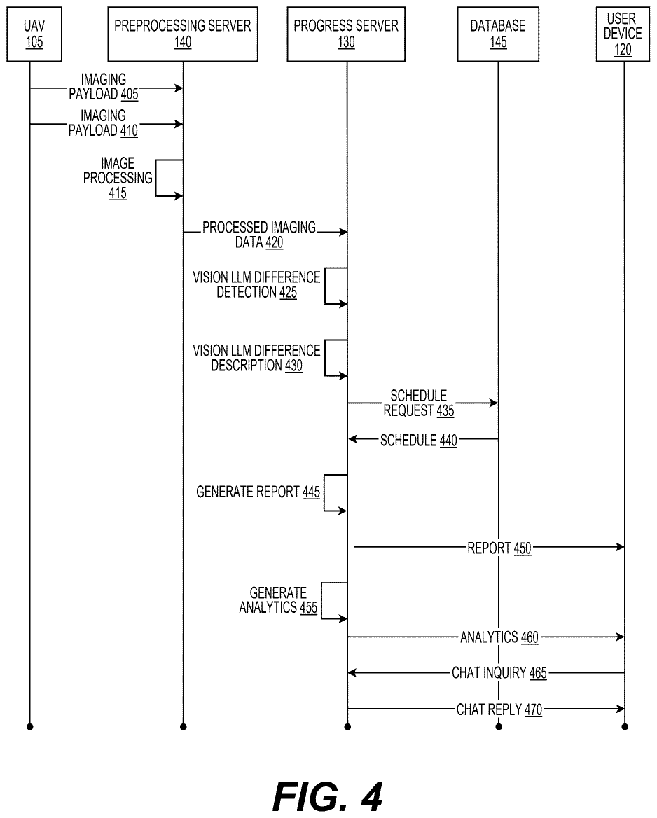

FIG. 4 shows a call flow diagram of the system 100, according to aspects of the disclosure. The call flow depicted in FIG. 4 depicts a sequence of operations and communications between UAV 105, preprocessing server 140, progress server 130, database 145, and user device 120.

At step 405, UAV 105 may transmit a first imaging payload to preprocessing server 140 at a time T1. The imaging payload may include one or more imaging data, video data, and/or metadata. Each of the source files may include various metadata. For example, the metadata may include a latitude, a longitude, an altitude, a time stamp, an identifier of the camera 110, an identifier of the UAV 105, a number of pixels, a pixel height, a pixel width, an aspect ratio, a file type, a flight identifier, a job identifier, a region of interest identifier, an entity identifier, an operator identifier, a user identifier, a customer identifier, geolocation data, sensor data, lens data, photographic settings (including aperture, ISO, and/or shutter speed), sensor calibration data, and/or sensor angle (e.g., pitch, roll, and/or yaw).

Imaging data included in the imaging payload may be generated by UAV 105 (e.g., via camera 110-1), including traditional optical (e.g., RGB), thermal (e.g., infrared), near-infrared, Light Detection and Ranging, (LiDAR), and other known imaging techniques. One of ordinary skill in the art will appreciate that while UAV 105 is shown in FIG. 4 as the entity providing imaging payloads to preprocessing server 140, this is only exemplary. For example, a ground-based camera (or any additional camera(s)) may complement or replace UAV 105 in some aspects of the disclosure. In such examples, the additional camera(s) may each transmit imaging payloads of a similar scene of a project site (e.g., similar to FIGS. 3A and 3B).

At step 410, UAV 105 may transmit a second imaging payload to preprocessing server 140 at a time T2, occurring after T1. The imaging payload may include imaging data, video data, and/or metadata. Each of the source files may include any of the metadata mentioned above in step 405. The imaging data corresponding to step 410 may generally be taken from a substantially similar frame of reference as the imaging data corresponding to step 405. The device transmitting the second imaging payload may be the same device as the device that transmitted the first imaging payload. In other embodiments, the device transmitting the second imaging payload may be different from the device that transmitted the first imaging payload.

In step 415, the preprocessing server 140 may perform one or more imaging processing operations. Image processing may include optimization of both T1 and T2 imaging data (e.g., from steps 405 and 410). The preprocessing server 140 may execute a series of data conditioning steps to optimize imaging payloads for efficient analysis by the progress server 130. These one or more steps may include image format conversion, resolution normalization, geospatial alignment, noise reduction, and/or compression to ensure uniformity across various imaging devices. The preprocessing server may also cluster imaging payloads based on various schema. A schema may define a particular set of metadata, a particular set of values of the metadata, a particular relationship between values of the metadata, particular thresholds, etc., that are used to cluster, classify, and/or validate the imaging payloads.

Upon receiving raw imaging payloads from UAV 105, the preprocessing server 140 may validate image integrity, and check for corrupted images (and/or discard such corrupted images), missing metadata, and inconsistent formats. The preprocessing server may adjust the image payloads by correcting lens distortions, adjusting white balance, and standardizing resolutions. To align before-and-after images, preprocessing server 140 may apply feature-based matching to correct perspective differences between images. Noise reduction techniques may be applied to images to enhance clarity.

In step 420, preprocessing server 140 may transmit the processed imaging data corresponding to imaging payloads 405 and 410 to progress server 130.

In step 425, progress server 130 may execute one or more operations using vision LLM 135 to analyze temporally spaced imaging payloads 405 and 410. Progress server 130 may compare the imaging payloads 405 and 410 via computer vision techniques such as feature extraction and one or more deep learning models. Features extracted may include shapes, textures, edges, colors, or higher-level structures (e.g., a roof, a window, a door). The output of the feature extraction may be a structured data representation (e.g., numerical vectors) that capture essential visual information from the imaging payloads. These structured data representations may be utilized by further downstream steps. In some instances, progress server 130 may determine that no changes have occurred, and the call flow may terminate. In the exemplary call flow of FIG. 4, it is assumed that one or more differences are detected (e.g., similar to FIGS. 3A-3B). After determining that differences are present, progress server 130 may generate a list of detected changes. The detected differences may be similar to those described in FIG. 3B, for example.

In step 430, progress server 130 may generate, using the vision LLM 135, structured, natural-language descriptions of the changes detected in step 425. Step 430 may translate image-based differences into standardized and qualitative textual summaries. A transformer-based neural network (e.g., the vision LLM 135) may classify the generated differences (e.g., semantic classification). For example, a label or descriptive category may be applied to one or more changes (e.g., “foundation poured”, “structure added) to characterize the change. The textual summaries generated may include standardized descriptions, including terminology from standards organization and reference materials such as International Project Specifications Institute (CSI) MasterFormat.

Step 430 may also include a determination of where the image payloads are located (e.g., where the image payloads are captured) on a project site. For aerial imagery, the image payloads may be determined to be within a predefined UAV boundary. For ground imagery, the location of the scene relative to the minimap may be extracted. Progress server 130 may perform deduplication on imaging payloads if multiple image pairs (e.g., before/after) are determined to be located at the same location. Additional metadata as well as other sources such as a site minimap (including location names), blueprints, and predefined material categories may be referenced from the imaging payloads to determine where (e.g., minimap location, project, building, level, area) on the project site the imaging payloads were taken.

In an example, if new drywall is detected, the progress server 130 may output “New drywall installed on the north-facing wall in Zone 3.” Similarly, if HVAC work has progressed, the progress server 130 may describe the change as “Ductwork placed above the east corridor ceiling.” The progress server 130 may reference metadata in the processed imaging data, during step 430. For example, the progress server 130 may refer to geolocation metadata in the processed imaging data to assist in the determination of where an image in the imaging payload is located.

In step 435, the progress server 130 queries the database 145 to retrieve relevant scheduling data corresponding to the detected changes identified in step 425. The progress server 130 may query the SQL scheduling database 145, which may store structured information about the project's planned activities, including information such as activity ID, activity name, start date, finish date, location ID, and building level (if applicable). In some aspects, the progress server 130 may query a specific task or portion of a task corresponding to a described change from step 430. For example, the progress server 130 may describe that drywall has been raised and may query the database 145 specifically for scheduling information related to drywall. The database 145 may also include a project-specific Primavera P6 schedule, which may itself include activity IDs & names, work breakdown structure (WBS), start & finish dates, task dependencies & relationships, resource assignments, critical path method (CPM) analysis, baseline tracking (e.g., early, on time, and late), and milestones. In a step 440, database 145 may provide the relevant project scheduling data to the progress server 130.

In step 445, progress server 130 may generate a progress report. The progress server 130 may analyze relevant scheduling data received during step 440, such as activity ID, activity name, start date, finish date, location ID, and building level and may compare the progress detected in step 425 and described in step 430 against the scheduling data. Progress server 130 may evaluate the actual completion timing of the changes and may classify the change into one of three categories, scope started early, scope on time, and scope occurring late, based on the scheduling data.

Progress server 130 may automatically flag or indicate potential schedule deviations in the generated progress report. In an example, the progress server 130 may have initially described (during step 430) drywall installation on an exemplary 5th floor, Zone 3, as completed two days ago. When the progress server 130 retrieves the planned schedule in step 445, the progress server 130 notes that the aforementioned work was scheduled to start next week. The progress server 130 may then classify the task as “Scope Started Early” and includes this information in the progress report. The systems, devices, and methods and the disclosure thus integrate scheduling data with automated descriptive progress tracking to generate timely and relevant progress reports.

In step 440, progress server 130 may transmit the generated progress report to the user device 120. As previously noted, user device 120 may be a smartphone, computer, server, etc. A user may then view the generated progress report.

In some aspects of the disclosure, the call flow shown in FIG. 4 may terminate upon delivery of the generated progress report to the user device 120 in step 450. In some aspects of the disclosure, additional steps may follow step 450 (e.g., steps 455, 460, 465, and 470). It should be noted that analytics (steps 455 and 460) and chat (steps 465) may be implemented alone or in combination in any order following step 445.

In step 455, progress server 130 may generate analytics. Analytics may be generated by determining the project activity and associating it with a date, based on understanding the progression of the project. This understanding may be derived by detecting differences between temporally spaced imageries or by analyzing progress-to-date from a single imagery. The detected project activity may then be associated with specific locations within a project, which may include particular areas on the exterior or individual rooms on the interior. For example, the system 100 may determine a percentage of completion for various locations over time by quantifying the number of rooms containing certain categorized project activities.

The generated analytics may generate project site analytics to measure task completion, schedule adherence, resource use, and delays. This information may allow users to identify issues, adjust schedules, and allocate resources more efficiently. Progress server 130 may also generate enterprise analytics to analyze multiple projects, comparing performance, detecting trends, and highlighting recurring delays or inefficiencies across a broader project portfolio. In step 460, progress server 130 may provide the generated analytics to user device 120.

A chat function may provide a user with an interactive means to query project progress data without manually searching through reports or schedules. This feature may enable users to ask real-time questions about task completion, schedule adherence, material deliveries, and workforce productivity. While the term “chat” is primarily used herein to describe a traditional LLM text-based chatbot, one of ordinary skill in the art will appreciate that “chat” may also refer to voice chat as well.

In step 465, a user (via user device 120) may query the progress server 130 with a chat inquiry. For example, a user may ask “What is the drywall completion status on Level 3?” or “Which tasks are behind schedule?” The progress server 130 may retrieve relevant data from a previously generated report or may itself query database 145 for information. The progress server 130 may then generate a structured response to the inquiry based on the detected changes and the scheduling data. In an example, human experts may label anticipated results from imagery analysis. The vision LLM 135 may be fine-tuned using various prompt engineering techniques, such as chain of thought reasoning, output constraints, and reflection. Additionally, vision-specific techniques, such as attention mechanisms and manipulation of 360-degree imagery, may enhance multimodal analysis by the vision LLM 135. For instance, converting a 2:1 equirectangular image to a cubic projection before analysis by the vision LLM 135 may help eliminate errors related to warping at the top of the image. In step 470, the progress server 130 provides the generated response to the user device 120.

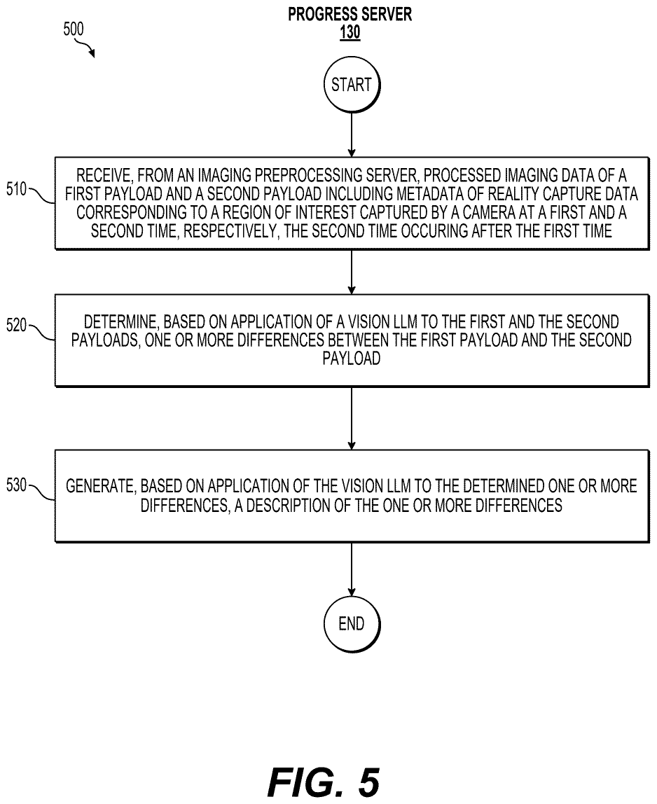

FIG. 5 depicts an example method performed by progress server 130 for tracking project progress, according to aspects of this disclosure. In step 510, the progress server 130 may receive processed imaging data from the preprocessing server 140. The processed imaging data may include a first payload and a second payload, which correspond to video and/or imaging collected at two different times (T1 and T2). The imaging payloads contain image/video data, metadata, and other sensor data captured by UAVs, ground-based cameras, or other imaging devices. While FIG. 5 describes a camera, one of ordinary skill in the art will appreciate that the camera is used to describe any suitable imaging system and/or imaging sensor, such as those corresponding to cameras 110-1 and 110-2.

In a step 520, the progress server 130 applies a vision LLM (e.g., the vision LLM 135) to both the first and second payloads to identify differences between the two images. The progress server 130 may apply a vision LLM that compares visual elements, such as structural modifications, material installations, and equipment movement. The progress server 130 may detect changes by leveraging pixel-wise differencing, feature matching, and/or semantic segmentation. The progress server 130 may, using the vision LLM 135, distinguish between actual progress (e.g., a new wall installed) and incidental changes (e.g., temporary debris or lighting differences), ensuring that only relevant project changes are captured.

In step 530, the progress server 130 may generate a structured description of the detected differences via the vision LLM 135. Progress server 130 may describe detected changes in relevant natural-language text descriptions. For example, if drywall installation was detected between the first and second imaging payloads, the progress server 130 may generate a summary such as “Drywall installed on the north-facing wall, Level 3, Zone 2.” The descriptions and summaries may be used downstream for reports, analytics, and chatbot responses.

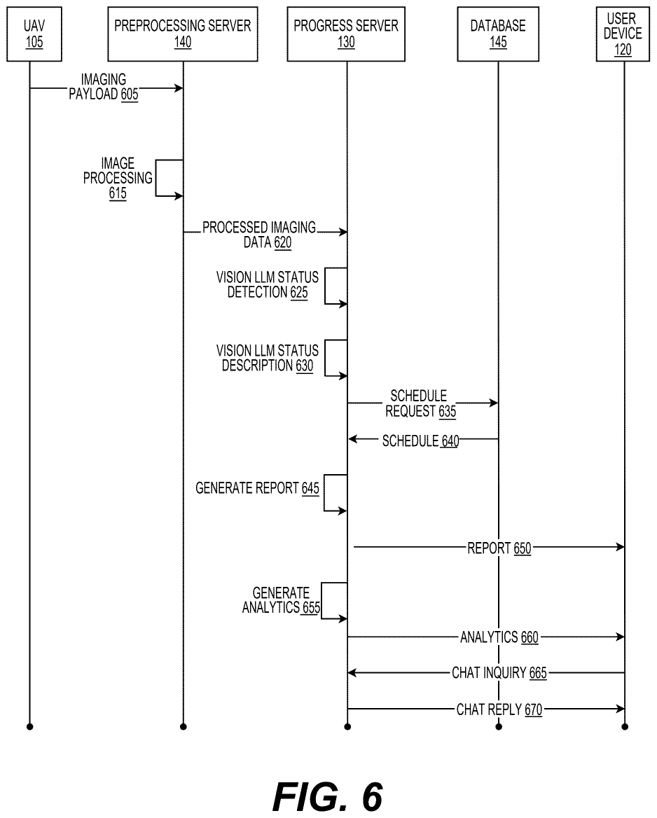

FIG. 6 shows a call flow diagram of the system 100, according to aspects of the disclosure. The call flow depicted in FIG. 6 depicts a sequence of operations and communications between UAV 105, preprocessing server 140, progress server 130, database 145, and user device 120. Unlike the call flow 400, the call flow 600 does not utilize temporally spaced imaging data (e.g., imaging payload 410), and instead describes a use case of applying system 100 to a single set (e.g., temporally contemporaneously captured) of imaging data to generate a description of what is present in the imaging data.

At step 605, the UAV 105 may transmit an imaging payload to the preprocessing server 140. The imaging payload may include one or more imaging data, video data, and/or metadata. Each of the source files may include various metadata. For example, the metadata may include a latitude, a longitude, an altitude, a time stamp, an identifier of the camera 110, an identifier of the UAV 105, a number of pixels, a pixel height, a pixel width, an aspect ratio, a file type, a flight identifier, a job identifier, a region of interest identifier, an entity identifier, an operator identifier, a user identifier, a customer identifier, geolocation data, sensor data, lens data, photographic settings (including aperture, ISO, and/or shutter speed), sensor calibration data, and/or sensor angle (e.g., pitch, roll, and/or yaw).

The imaging data included in the imaging payload may be generated by UAV 105 (e.g., via camera 110-1), including traditional optical (e.g., RGB), thermal (e.g., infrared), near-infrared, Light Detection and Ranging, (LiDAR), and other known imaging techniques. One of ordinary skill in the art will appreciate that while the UAV 105 is shown in FIG. 6 as the entity providing the imaging payload to preprocessing server 140, this is only exemplary. For example, a ground-based camera (or any additional camera(s)) may complement or replace the UAV 105 in some aspects of the disclosure. In such examples, the additional camera(s) may each transmit imaging payloads of a similar scene of a project site (e.g., similar to FIGS. 3A and 3B).

In step 615, the preprocessing server 140 may perform one or more imaging processing operations. Image processing may include optimization of the imaging data (e.g., from step 605). The preprocessing server 140 may execute a series of data conditioning steps to optimize the imaging payload for efficient analysis by the progress server 130. These one or more steps may include image format conversion, resolution normalization, geospatial alignment, noise reduction, and/or compression to ensure uniformity across various imaging devices. The preprocessing server 140 may also cluster portions of the imaging payload based on various schema. A schema may define a particular set of metadata, a particular set of values of the metadata, a particular relationship between values of the metadata, particular thresholds, etc., that are used to cluster, classify, and/or validate the imaging payload.

Upon receiving raw imaging payload from UAV 105, the preprocessing server 140 may validate image integrity, and check for corrupted images (and/or discard such corrupted images), missing metadata, and inconsistent formats. The preprocessing server 140 may adjust the image payload by correcting lens distortions, adjusting white balance, and standardizing resolutions. The preprocessing server 140 may apply feature-based matching to correct perspective differences between images. Noise reduction techniques may be applied to images to enhance clarity.

In step 620, the preprocessing server 140 may transmit the processed imaging data corresponding to the imaging payload 605 to the progress server 130.

In step 625, the progress server 130 may execute one or more operations using the vision LLM 135 to process the imaging payload 605 to determine a status in the imaging payload 605. As used herein, a “status” broadly refers to identification, classification, characterization of objects, conditions, states, or other visually discernable attributes derivable from imaging data. For example, a status may indicate the presence or absence of a particular object or condition on the project site, such as equipment, material, or personnel. Additionally, a status may include qualitative or quantitative assessments, including condition, integrity, functionality, or current stage of progress (e.g., whether an element is complete, incomplete, damaged, or intact). Status may further encompass operational states of equipment (e.g., active, inactive, malfunctioning), or broader environmental and contextual conditions like weather, erosion, or vegetation growth. Status may also include changes, variances, or transformations determined in imaging payload(s) captured at different times, including newly added, modified, repositioned, or removed elements from a same imaging scene. Accordingly, a status may encompass any visually discernable attributes or characteristics identified, analyzed, determined, or otherwise interpreted by the progress server 130.

As used herein, the term “object” may refer to any identified subject, element, or region within the processed imaging data the progress server 130 recognizes, detects, classifies, or otherwise processes. An object may be, for example, a physical structure on a project site, a piece of equipment, a person, a site condition, or any other visually discernible characteristic within the imagery. The term “object” is not limited to a particular size, shape, or physical composition, and may include both tangible and intangible features (e.g., shadows, reflections, or other visual indicators). In some aspects, an object can also include a difference or change between two or more temporally separated images of the project site, such that the detected object corresponds to a modification, a newly added element, or a removed element. Unless stated otherwise, the term “object” is to be broadly interpreted to include all such possible structures, conditions, or visual characteristics that may be identified or characterized by the system 100.

The progress server 130 may examine the imaging payload 605 via computer vision techniques such as feature extraction and one or more deep learning models. Features extracted may include shapes, textures, edges, colors, or higher-level structures (e.g., a roof, a window, a door). The output of the feature extraction may be a structured data representation (e.g., numerical vectors) that capture essential visual information from the imaging payload. These structured data representations may be utilized by further downstream steps. In some instances, the progress server 130 may determine that there are no determined statuses, and the call flow may terminate. In the exemplary call flow of FIG. 6, it is assumed that one or more statuses are detected (e.g., similar to FIGS. 3A-3B). After determining that one or more statuses are present, the progress server 130 may generate a list of detected statuses. In a simplified example, the progress server 130 may determine a status such as “there is drywall erected on the south wall of the third floor” based on the processed imaging data from step 615. In contrast to the call flow of FIG. 4, a status has been detected with reference to only contemporaneously captured imaging data (e.g., imaging payload 605).

In step 630, the progress server 130 may generate, using the vision LLM 135, structured, natural-language descriptions of the statuses detected in step 625. Step 630 may translate image-based statuses into standardized and qualitative textual summaries. A transformer-based neural network (e.g., the vision LLM 135) may classify the generated statuses (e.g., semantic classification). For example, a label or descriptive category may be applied to one or more statuses (e.g., “foundation present”, “structure present,” etc.) to characterize the status. The textual summaries generated may include standardized descriptions, including terminology from standards organization and reference materials such as International Project Specifications Institute (CSI) MasterFormat.

Step 630 may also include a determination of where the image payload(s) are located (e.g., where the image payload is captured) on a project site. For aerial imagery, the image payload may be determined to be within a predefined UAV boundary. For ground imagery, the location of the scene relative to the minimap may be extracted. The progress server 130 may perform deduplication on the imaging payload if multiple image pairs are determined to be located at the same location. Additional metadata as well as other sources such as a site minimap (including location names), blueprints, and predefined material categories may be referenced from the imaging payloads to determine where (e.g., minimap location, project, building, level, area) on the project site the imaging payload was taken.

In an example, if drywall is detected, the progress server 130 may output “Drywall present on the north-facing wall in Zone 3.” Similarly, if HVAC work has occurred, the progress server 130 may describe the status as “Ductwork present above the east corridor ceiling.” The progress server 130 may reference metadata in the processed imaging data, during step 630. For example, the progress server 130 may refer to geolocation metadata in the processed imaging data to assist in the determination of where an image in the imaging payload is located.

In step 635, the progress server 130 queries the database 145 to retrieve relevant scheduling data corresponding to the detected statuses identified in step 625. The progress server 130 may query the SQL scheduling database 145, which may store structured information about the project's planned activities, including information such as activity ID, activity name, start date, finish date, location ID, and building level (if applicable). In some aspects, the progress server 130 may query a specific task or portion of a task corresponding to a described status from step 630. For example, the progress server 130 may describe that drywall is present and may query the database 145 specifically for scheduling information related to drywall. The database 145 may also include a project-specific Primavera P6 schedule, which may itself include activity IDs & names, work breakdown structure (WBS), start & finish dates, task dependencies & relationships, resource assignments, critical path method (CPM) analysis, baseline tracking (e.g., early, on time, and late), and milestones. In step 640, database 145 may provide the relevant project scheduling data to the progress server 130.

In step 645, the progress server 130 may generate a progress report. The progress server 130 may analyze relevant scheduling data received during step 640, such as activity ID, activity name, start date, finish date, location ID, and building level and may compare the status detected in step 625 and described in step 630 against the scheduling data. The progress server 130 may evaluate the actual completion timing of the status and may classify the status into one of three categories, scope started early, scope on time, and scope occurring late, based on the scheduling data.

The progress server 130 may automatically flag or indicate potential schedule deviations in the generated progress report. In an example, the progress server 130 may have initially described (during step 630) drywall installation on an exemplary 5th floor, Zone 3, as completed two days ago. When the progress server 130 retrieves the planned schedule in step 640, the progress server 130 notes that the aforementioned work was scheduled to start next week. The progress server 130 may then classify the task as “Scope Started Early” and includes this information in the progress report. The systems, devices, and methods and the disclosure thus integrate scheduling data with automated descriptive progress tracking to generate timely and relevant progress reports.

In step 650, the progress server 130 may transmit the generated status report to the user device 120. As previously noted, the user device 120 may be a smartphone, computer, server, etc. A user may then view the generated status report.

In some aspects of the disclosure, the call flow shown in FIG. 6 may terminate upon delivery of the generated status report to the user device 120 in step 650. In some aspects of the disclosure, additional steps may follow step 650 (e.g., steps 655, 660, 665, and 670). It should be noted that analytics (steps 655 and 660) and chat (steps 465) may be implemented alone or in combination in any order following step 645.

In step 655, the progress server 130 may generate analytics. Analytics may be generated by determining project activity and associating it with a date, based on understanding the progression of project. This understanding may be derived by detecting one or more statuses associated with progress-to-date from single imagery. The detected project activity may then be associated with specific locations within a project, which may include particular areas on the exterior or individual rooms on the interior. The system 100 may determine a percentage of completion for various locations over time by quantifying the number of rooms containing certain categorized project activities. This methodology represents one example of the type of analytics that may be generated.

The generated analytics may provide project site analytics to measure task completion, schedule adherence, resource use, and delays. This information may allow users to identify issues, adjust schedules, and allocate resources more efficiently. The progress server 130 may also generate enterprise analytics to analyze multiple projects, comparing performance, detecting trends, and highlighting recurring delays or inefficiencies across a broader project portfolio. In step 660, the progress server 130 may provide the generated analytics to the user device 120.

A chat function may provide a user with an interactive means to query project progress data without manually searching through reports or schedules. This feature may enable users to ask real-time questions about task completion, schedule adherence, material deliveries, and workforce productivity. While the term “chat” is primarily used herein to describe a traditional LLM text-based chatbot, one of ordinary skill in the art will appreciate that “chat” may also refer to voice chat as well.

In step 665, a user (via user device 120) may query the progress server 130 with a chat inquiry. For example, a user may ask “What is the drywall completion status on Level 3?” or “Which tasks are behind schedule?” The progress server 130 may retrieve relevant data from a previously generated report or may itself query database 145 for information. The progress server 130 may then generate a structured response to the inquiry based on the detected changes and the scheduling data. In an example, human experts may label anticipated results from imagery analysis. The vision LLM 135 may be fine-tuned using various prompt engineering techniques, such as chain of thought reasoning, output constraints, and reflection. Additionally, vision-specific techniques, such as attention mechanisms and manipulation of 360-degree imagery, may enhance multimodal analysis by the vision LLM 135. For instance, converting a 2:1 equirectangular image to a cubic projection before analysis by the vision LLM 135 may help eliminate errors related to warping at the top of the image. In step 670, the progress server 130 provides the generated response to the user device 120.

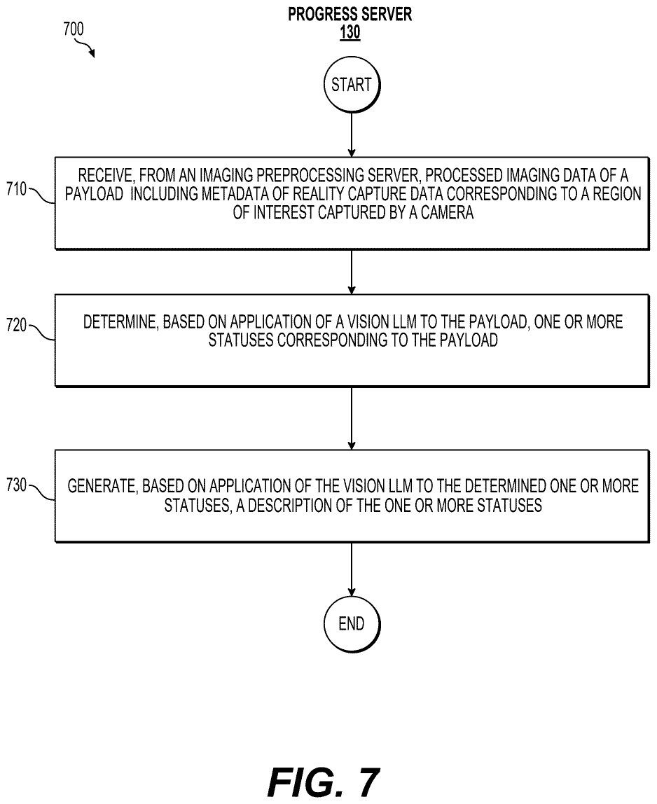

FIG. 7 depicts an example method performed by the progress server 130 for tracking project status, according to aspects of this disclosure. The method 700 may encompass a use case of applying system 100 to a single set (e.g., temporally contemporaneously captured) of imaging data to generate a description of what is present in the imaging data. As a non-limiting example, the method 700 may not utilize temporally spaced imaging data. In step 710, the progress server 130 may receive processed imaging data from the preprocessing server 140. The processed imaging data may include a payload which corresponds to video and/or imaging taken contemporaneously (e.g., within a timeframe on the order of minutes). The imaging payload contains image/video data, metadata, and other sensor data captured by UAVs, ground-based cameras, or other imaging devices. While FIG. 7 describes a camera, one of ordinary skill in the art will appreciate that the camera is used to describe any suitable imaging system and/or imaging sensor.

In step 720, the progress server 130 applies a vision LLM (e.g., the vision LLM 135) to the payload to identify one or more statuses. The progress server 130 may apply a vision LLM that analyzes visual elements, such as structural features, material installations, and equipment locations. The progress server 130 may detect statuses by leveraging pixel-wise differencing, feature matching, and/or semantic segmentation. The progress server 130 may, using the vision LLM 135, distinguish between an actual status (e.g., a wall is present) and incidental changes (e.g., temporary debris), ensuring that only relevant project statuses are captured.

In step 730, the progress server 130 may generate a structured description of the detected statuses via the vision LLM 135. The progress server 130 may describe detected statuses in relevant natural-language text descriptions. For example, if drywall was detected between in the imaging payload, the progress server 130 may generate a summary such as “Drywall present on the north-facing wall, Level 3, Zone 2.” The descriptions and summaries may be used downstream for reports, analytics, and chatbot responses.

In this way, the present disclosure provides methods and systems for automatically detecting, describing, and contextualizing changes in project imaging data. The present disclosure provides a technical improvement in tracking and analyzing project imaging data by more accurately and quickly detecting changes, more efficiently processing imaging data, and generating progress updates in real-time or near real-time. Moreover, the present disclosure enables progress tracking using metadata and structured analysis rather than requiring full manual review of image files or pre-modeled plans.

In an example, a computer-implemented method for automatically tracking construction progress may include receiving, at one or more processors communicatively coupled to one or more image sensors, a set of processed imaging data including one or more images of a construction site. The one or more images may have been captured by the one or more image sensors each equipped with an imaging system. The computer-implemented method may further include processing, using a vision large language model (LLM) executed by the one or more processors, the one or more images to identify a status at the construction site of (i) at least one physical structure or (ii) at least one site condition. The processing may include performing feature extraction to generate one or more structured data representations of the one or more images, identifying an object within the one or more structured data representations indicative of a status at the construction site, classifying the object using a transformer-based neural network to determine a semantic category of the status and generating a textual description that characterizes the identified status at the construction site based on at least the semantic category of the status.

Any of the systems, devices, and methods disclosed herein may may include any of the following features. The one or more image sensors may include a first image sensor and a second image sensor, the first image sensor and the second image sensor being a same image sensor or different image sensors. The one or more images may include one or more first images that have been captured by the first image sensor at a first time and one or more second images that have been captured by the second image sensor at a second time. The identified object within the one or more structured data representations may be a modification between the one or more first images and the one or more second images, and the status at the construction site may be a change at the construction site indicated by the modification.

The one or more images each may include associated metadata, and the one or more structured data representations may be generated further based on the metadata associated with the one or more images.

The set of processed imaging data may be based on one or more source files that have had at least one of feature extraction, semantic segmentation, or edge detection applied by a preprocessing server.

The set of processed imaging data may include metadata including at least one of timestamp data, geolocation data, sensor data, lens data, photographic setting data, sensor calibration data, or sensor angle data, and the identifying of the status at the construction site may be further based on the metadata.

The textual description may include at least one standardized descriptive term.

The computer-implemented method may further include transmitting, by the one or more processors, a scheduling request to a scheduling server, receiving, by the one or more processors, a scheduling response including scheduling data from the scheduling server, and utilizing, by the one or more processors, the vision LLM to generate a progress report. The progress report may be based on at least one of the at least one description or the scheduling data.

The computer-implemented method may further include utilizing, by the one or more processors, the vision LLM to generate an analysis of the construction site. The analysis may be based on the progress report.

The computer-implemented method may further include receiving, by the one or more processors, a data inquiry from a user device. The data inquiry may include at least one reference to a portion of the construction site.

The computer-implemented method may further include utilizing, by the one or more processors, the vision LLM to generate a data response. The data response may be based on at least one of the progress report, the scheduling data, or the data inquiry.

The scheduling data may include at least one of an activity ID, an activity name, a start date, a finish date, a location ID, or a building level.

The progress report may be a first progress report. The first progress report may be further based on a second progress report generated by the vision LLM.

This disclosure may further include a system for automatically tracking construction progress, the system including one or more processors, and one or more non-transitory computer readable media storing instructions which, when executed by the one or more processors, cause the one or more processors to perform operations including receiving, a set of processed imaging data including one or more images of a construction site. The one or more images may have been captured by one or more image sensors each equipped with an imaging system, and processing, using a vision large language model (LLM), the one or more images to identify a status at the construction site of (i) at least one physical structure or (ii) at least one site condition. The processing may include performing feature extraction to generate one or more structured data representations of the one or more images, identifying an object within the one or more structured data representations indicative of a status at the construction site, classifying the object using a transformer-based neural network to determine a semantic category of the status, and generating a textual description that characterizes the identified status at the construction site based on at least the semantic category of the status.

Any of the systems, devices, and methods disclosed herein may may include any of the following features. The one or more image sensors may include a first image sensor and a second image sensor, the first image sensor and the second image sensor may be a same image sensor or different image sensors. The one or more images may include one or more first images that have been captured by the first image sensor at a first time and one or more second images that have been captured by the second image sensor at a second time, and the identified object within the one or more structured data representations may be a modification between the one or more first images and the one or more second images, and the status at the construction site may be a change at the construction site indicated by the modification.

The one or more images each may include associated metadata, and the one or more structured data representations may be generated further based on the metadata associated with the one or more images.

The set of processed imaging data may be based on one or more source files that may have had at least one of feature extraction, semantic segmentation, or edge detection applied by a preprocessing server.

The set of processed imaging data may include metadata including at least one of timestamp data, geolocation data, sensor data, lens data, photographic setting data, sensor calibration data, or sensor angle data. The identifying of the status at the construction site may be further based on the metadata.

The textual description may include at least one standardized descriptive term.

This disclosure further may further include one or more non-transitory computer readable media for automatically tracking construction progress, the one or more non-transitory computer readable media storing instructions which, when executed by one or more processors, cause the one or more processors to perform operations including receiving a set of processed imaging data including one or more images of a construction site. The one or more images may have been captured by one or more image sensors each equipped with an imaging system, and processing, using a vision large language model (LLM), the one or more images to identify a status at the construction site of (i) at least one physical structure or (ii) at least one site condition. The processing may include performing feature extraction to generate one or more structured data representations of the one or more images, identifying an object within the one or more structured data representations indicative of a status at the construction site, classifying the object using a transformer-based neural network to determine a semantic category of the status, and generating a textual description that characterizes the identified status at the construction site based on at least the semantic category of the status.

Any of the systems, devices, and methods disclosed herein may may include any of the following features. The one or more image sensors may include a first image sensor and a second image sensor, the first image sensor and the second image sensor may be a same image sensor or different image sensors. The one or more images may include one or more first images that have been captured by the first image sensor at a first time and one or more second images that have been captured by the second image sensor at a second time. The identified object within the one or more structured data representations may be a modification between the one or more first images and the one or more second images, and the status at the construction site may be a change at the construction site indicated by the modification.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

We claim:

1. A computer-implemented method for automatically tracking construction progress, the computer-implemented method comprising:
receiving, at one or more processors communicatively coupled to one or more image sensors, a set of processed imaging data comprising one or more images of a construction site, wherein the one or more images have been captured by the one or more image sensors each equipped with an imaging system; and
processing, using a vision large language model (LLM) executed by the one or more processors, the one or more images to identify a status at the construction site of (i) at least one physical structure or (ii) at least one site condition, wherein the processing comprises:
performing feature extraction to generate one or more structured data representations of the one or more images;
identifying an object within the one or more structured data representations indicative of a status at the construction site;
classifying the object using a transformer-based neural network to determine a semantic category of the status; and
generating a textual description that characterizes the identified status at the construction site based on at least the semantic category of the status.

2. The computer-implemented method of claim 1,
wherein the one or more image sensors comprise a first image sensor and a second image sensor, the first image sensor and the second image sensor being a same image sensor or different image sensors,
wherein the one or more images comprise one or more first images that have been captured by the first image sensor at a first time and one or more second images that have been captured by the second image sensor at a second time, and
wherein the identified object within the one or more structured data representations is a modification between the one or more first images and the one or more second images, and the status at the construction site is a change at the construction site indicated by the modification.

3. The computer-implemented method of claim 1, wherein the one or more images each include associated metadata, and the one or more structured data representations are generated further based on the metadata associated with the one or more images.

4. The computer-implemented method of claim 1, wherein the set of processed imaging data is based on one or more source files that have had at least one of feature extraction, semantic segmentation, or edge detection applied by a preprocessing server.

5. The computer-implemented method of claim 1, wherein the set of processed imaging data includes metadata comprising at least one of timestamp data, geolocation data, sensor data, lens data, photographic setting data, sensor calibration data, or sensor angle data, and wherein the identifying of the status at the construction site is further based on the metadata.

6. The computer-implemented method of claim 1, wherein the textual description includes at least one standardized descriptive term.

7. The computer-implemented method of claim 1, further comprising:
transmitting, by the one or more processors, a scheduling request to a scheduling server;
receiving, by the one or more processors, a scheduling response including scheduling data from the scheduling server; and
utilizing, by the one or more processors, the vision LLM to generate a progress report, wherein the progress report is based on at least one of the at least one description or the scheduling data.

8. The computer-implemented method of claim 7, further comprising:
utilizing, by the one or more processors, the vision LLM to generate an analysis of the construction site, wherein the analysis is based on the progress report.

9. The computer-implemented method of claim 7, further comprising:
receiving, by the one or more processors, a data inquiry from a user device, wherein the data inquiry includes at least one reference to a portion of the construction site.

10. The computer-implemented method of claim 9, further comprising:
utilizing, by the one or more processors, the vision LLM to generate a data response, wherein the data response is based on at least one of the progress report, the scheduling data, or the data inquiry.

11. The computer-implemented method of claim 7, wherein the scheduling data includes at least one of an activity ID, an activity name, a start date, a finish date, a location ID, or a building level.

12. The computer-implemented method of claim 7, wherein the progress report is a first progress report, wherein the first progress report is further based on a second progress report generated by the vision LLM.

13. A system for automatically tracking construction progress, the system comprising:
one or more processors; and
one or more non-transitory computer readable media storing instructions which, when executed by the one or more processors, cause the one or more processors to perform operations comprising:
receiving, a set of processed imaging data comprising one or more images of a construction site, wherein the one or more images have been captured by one or more image sensors each equipped with an imaging system; and
processing, using a vision large language model (LLM), the one or more images to identify a status at the construction site of (i) at least one physical structure or (ii) at least one site condition, wherein the processing comprises:
performing feature extraction to generate one or more structured data representations of the one or more images;
identifying an object within the one or more structured data representations indicative of a status at the construction site;
classifying the object using a transformer-based neural network to determine a semantic category of the status; and
generating a textual description that characterizes the identified status at the construction site based on at least the semantic category of the status.

14. The system of claim 13,
wherein the one or more image sensors comprise a first image sensor and a second image sensor, the first image sensor and the second image sensor being a same image sensor or different image sensors,
wherein the one or more images comprise one or more first images that have been captured by the first image sensor at a first time and one or more second images that have been captured by the second image sensor at a second time, and
wherein the identified object within the one or more structured data representations is a modification between the one or more first images and the one or more second images, and the status at the construction site is a change at the construction site indicated by the modification.

15. The system of claim 13, wherein the one or more images each include associated metadata, and the one or more structured data representations are generated further based on the metadata associated with the one or more images.

16. The system of claim 13, wherein the set of processed imaging data is based on one or more source files that have had at least one of feature extraction, semantic segmentation, or edge detection applied by a preprocessing server.

17. The system of claim 13, wherein the set of processed imaging data includes metadata comprising at least one of timestamp data, geolocation data, sensor data, lens data, photographic setting data, sensor calibration data, or sensor angle data, and wherein the identifying of the status at the construction site is further based on the metadata.

18. The system of claim 13, wherein the textual description includes at least one standardized descriptive term.

19. One or more non-transitory computer readable media for automatically tracking construction progress, the one or more non-transitory computer readable media storing instructions which, when executed by one or more processors, cause the one or more processors to perform operations comprising:
receiving a set of processed imaging data comprising one or more images of a construction site, wherein the one or more images have been captured by one or more image sensors each equipped with an imaging system; and
processing, using a vision large language model (LLM), the one or more images to identify a status at the construction site of (i) at least one physical structure or (ii) at least one site condition, wherein the processing comprises:
performing feature extraction to generate one or more structured data representations of the one or more images;
identifying an object within the one or more structured data representations indicative of a status at the construction site;
classifying the object using a transformer-based neural network to determine a semantic category of the status; and
generating a textual description that characterizes the identified status at the construction site based on at least the semantic category of the status.

20. The one or more non-transitory computer readable media of claim 19,
wherein the one or more image sensors comprise a first image sensor and a second image sensor, the first image sensor and the second image sensor being a same image sensor or different image sensors,
wherein the one or more images comprise one or more first images that have been captured by the first image sensor at a first time and one or more second images that have been captured by the second image sensor at a second time, and
wherein the identified object within the one or more structured data representations is a modification between the one or more first images and the one or more second images, and the status at the construction site is a change at the construction site indicated by the modification.
